(19) United States
(12) Patent Application Publication
(10) Pub. No.: US 2024/0054988 A1
(43) Pub. Date: Feb. 15, 2024

(54) Reduced Complexity Implementation for Acoustic Noise Canceling

(71) Applicant: Google LLC, Mountain View, CA (US)

(72) Inventors: Abhijit Shah, Foster City, CA (US); Guohua Sun, Santa Clara, CA (US); Lawrence Frederick Heyl, Williston, VT (US); Niel David Warren, Soquel, CA (US)

(21) Appl. No.: 17/763,742

(22) PCT Filed: Apr. 22, 2021
(86) PCT No.: PCT/US2021/028575

§ 371 Date: Oct. 27, 2022

(51) Int. Cl. G10K 11/178

(52) U.S. Cl. CPC G10K 11/17855; G10K 11/17854; G10K 11/17879; G10K 11/17885; G10K 2210/3053; G10K 2210/1081; G10K 2210/3027; G10K 2210/3026

(57) ABSTRACT

The subject matter described herein provides systems and techniques for filtering an audio signal using active noise cancellation (ANC). A channel response finite impulse response (CR FIR) filter in a conventional ANC system may be replaced with a two filter cascade configuration. The first filter in the cascade filter configuration may be a CR FIR filter with interleaved zero coefficients and the second filter may be a response interpolator filter that is a fixed interpolator. The CR FIR filter in the two filter cascade may be adaptive and may have its non-zero coefficients tracked, updated, adapted, and/or computed. The fixed interpolator in the two filter cascade may be fixed and therefore non-adaptive. The channel frequency response profile of the two filter cascade configuration may be similar to the channel frequency response profile of the conventional CR FIR filter that the cascade filter configuration replaces.

### BACKGROUND

An active noise cancellation (ANC) system reduces or removes noise for the user of an audio playback system based on the external noise received from feedforward microphones and/or the feedback microphones. Using these microphones, ANC systems emit an anti-noise audio signal from ambient noise, and add this signal to the audio output of the audio playback system so that it cancels or reduces noise at the eardrum of the user. In addition, these microphones are used to generate a correction audio signal from residual noise at the speaker of the audio playback system. The correction audio signal is also added or subtracted from the audio output of the audio playback system so that it cancels or reduces noise at the eardrum of the user. The computational architecture for such ANC system includes components that acquire/record the noise to be canceled, channel response filters that filter the noise using a transmission path transfer function and/or channel response filter, and components that subtract the resulting/recreated anti-noise signal and/or correction signal from the audio output. The channel response filters may include a channel response infinite impulse response (CR IIR) filter and a conventional channel response finite impulse response (CR FIR) filter. The coefficients associated with the taps of these filters may be constantly adapted to track the transmission path and/or channel response, because the transmission path and/or channel is constantly varying. However, as a result, the use of a conventional CR FIR filter may have several disadvantages. In particular, such a filter may have a large response duration, as a result of requiring a large number of taps, such as 64-2048 taps. In addition, use of such a filter will be computationally expensive, as a result of its complexity, and produce significant power consumption in the ANC system. Additionally, adapting and/or tracking coefficients for the taps of the conventional CR FIR filter will be computationally expensive and may lead to stability issues for the ANC system design.

### BRIEF SUMMARY

The present disclosure is directed to using a cascade filter configuration in an active noise canceling (ANC) system. The cascade filter configuration may include a simplified CR FIR filter and a response interpolator filter used in combination.

In general, one aspect of the subject matter described in this specification includes an active noise cancellation system. The system may include an infinite impulse response filter configured to filter a digital signal and output a first filtered digital signal. The system may further include a cascaded filter configuration in communication with the infinite impulse response filter. The cascaded filter configuration may be configured to filter the first filtered digital signal and output an audio signal. The infinite impulse response filter may be coupled between the analog to digital converter and the cascaded filter configuration. The cascaded filter configuration may include an adaptive finite impulse response filter configured to filter the first filtered digital signal and to output a second filtered digital signal, and may include a response interpolator filter configured to filter the second filtered digital signal and output the audio signal. The active noise cancellation system may include one, several or all of the following features. The active noise cancellation system may include an adaptive tracker in communication with the cascaded filter configuration. The adaptive tracker may be configured to track, based on a channel response, non-zero coefficients of at least one of the infinite impulse response filter and the adaptive finite impulse response filter. The non-zero coefficients may be used by the at least one of the infinite impulse response filter and the adaptive finite impulse response filter. The response interpolator filter may be a fixed interpolator. The cascaded filter configuration may have a frequency response of a finite impulse response filter with a greater number of taps than the number of taps of the cascaded filter configuration. The adaptive finite impulse response filter may have interleaved zero coefficients. The adaptive finite impulse response filter may be implemented as a polyphase filter. The infinite impulse response filter may be implemented as a polyphase filter. The active noise cancellation system may further include an analog to digital converter in communication with the infinite impulse response filter. The analog to digital converter may be configured to convert at least one analog signal to the digital signal. The system may further include a subtractor in communication with the cascaded filter configuration. The subtractor may be configured to receive a playback signal, and subtract the audio signal from the playback signal. The active noise cancellation system may be within an earbud.

Another aspect of the subject matter includes a process for active noise cancellation. A digital signal may be filtered to produce a first filtered digital signal using an infinite impulse response filter. The first filtered digital signal may be filtered to output a second filtered digital signal using an adaptive finite impulse response filter. The second filtered digital signal may be filtered using a response interpolator filter. An audio signal may be produced based on the output of the response interpolator filter. The non-zero coefficients of at least one of the infinite impulse response filter and the adaptive finite impulse response filter may be tracked based on a channel response. The non-zero coefficients may be output for use by the at least one of the infinite impulse response filter and the adaptive finite impulse response filter. At least one analog signal may be converted to the digital signal. A playback signal may be received. The audio signal may be subtracted from the playback signal.

Yet another aspect of the subject matter includes a non-transitory computer-readable medium storing instructions, that when executed by one or more processors, cause the one or more processors to perform various operations. A digital signal may be filtered to produce a first filtered digital signal using an infinite impulse response filter. The first filtered digital signal may be filtered to output a second filtered digital signal using an adaptive finite impulse response filter. The second filtered digital signal may be filtered using a response interpolator filter. An audio signal may be produced based on the output of the response interpolator filter. The non-zero coefficients of at least one of the infinite impulse response filter and the adaptive finite impulse response filter may be tracked based on a channel response. The non-zero coefficients may be output for use by the at least one of the infinite impulse response filter and the adaptive finite impulse response filter. At least one analog signal may be converted to the digital signal. A playback signal may be received. The audio signal may be subtracted from the playback signal.

Using a cascade filter configuration in the ANC system, instead of the conventional CR FIR filter design, may be advantageous. In particular, such a cascade filter configuration used in the ANC system design may have lower computational requirements, a lower number of taps, a reduced complexity, a lower power consumption, a fast response duration with faster convergence capabilities, a higher degree of stability and may be computationally inexpensive when compared to the use of a conventional CR FIR filter design.

For example, a CR FIR filter in a conventional ANC system may be replaced with a two filter cascade configuration. The first filter in the cascade filter configuration may be a CR FIR filter with interleaved zero coefficients and the second filter may be a response interpolator filter that is a fixed interpolator. The CR FIR filter in the two filter cascade may be adaptive and may have its non-zero coefficients tracked, updated, adapted, or computed using an adaptive tracker. The adaptive tracker may track the transmission path or channel response in order to update, adapt, or compute the coefficients of the CR FIR filter. The fixed interpolator in the two filter cascade is fixed and therefore non-adaptive. The fixed interpolator may have a fixed number of taps, such as 5-17 taps. The channel frequency response profile of the two filter cascade configuration may be similar to the channel frequency response profile of the conventional CR FIR filter that the cascade filter configuration replaces. The cascade filter configuration may have lower computational requirements when compared to conventional systems.

The cascade filter configuration used in ANC systems may have a reduced number of non-zero filter taps, such as two to five times fewer taps when compared to conventional systems. This may allow for fewer non-zero coefficients which the adaptive tracker may need to track, update, adapt, or compute. As another example, because computational complexity may be proportional to the number of non-zero filter taps in a filter, the use of the cascade filter configuration in the ANC system may lead to a lower computational complexity, such as two to five times lower, when compared to conventional systems. As a result, this may lead to a lower power consumption by the cascade filter and the ANC system. As yet another example, because only the CR FIR filter of the two filter cascade may be adaptive, there may be fewer coefficients and/or taps to adapt, such as four to eight times fewer coefficients/taps to adapt when compared to conventional systems. Such a factor associated with a fewer number of coefficients and/or taps to adapt may be determined by an interpolation ratio. Thus, for a K-fold fixed interpolation, various savings scaled to K, such as the number of coefficients and/or taps to be adapted, may be achieved. As a result of the fewer number of coefficients and/or taps to adapt, the coefficient tracking and/or adaptation for this CR FIR filter within the cascade filter configuration may be less complex. This may lead to faster convergence rates when compared to conventional systems.

### BRIEF DESCRIPTION OF THE DRAWINGS

FIG. 1 depicts a schematic illustration of an audio playback system in accordance with aspects of the disclosure.

FIG. 2 depicts a block diagram of an ANC system in accordance with aspects of the disclosure.

FIG. 3 depicts a block diagram of an ANC system, which has a reduced complexity, in accordance with aspects of the disclosure.

FIG. 4 shows example graphs of the channel frequency responses of filters used in ANC systems in accordance with aspects of the disclosure.

FIG. 5 depicts a block diagram of an example implementation of filters in an ANC system in accordance with aspects of the disclosure.

FIG. 6 is a flow diagram of an example process for filtering an audio signal in accordance with aspects of the disclosure.

FIG. 7 is a block diagram of an example electronic device in accordance with aspects of the disclosure.

### DETAILED DESCRIPTION

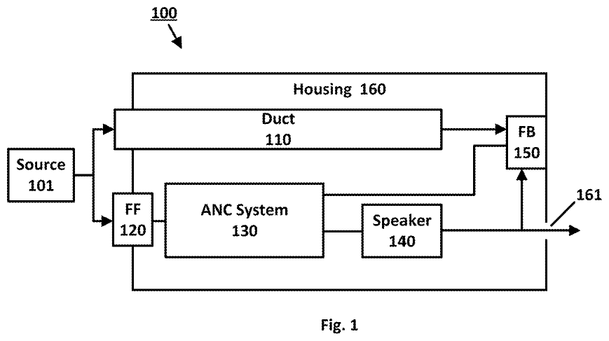

FIG. 1 depicts a schematic illustration of audio playback system 100. The audio playback system 100 may include a housing 160 that contains various components of the system, including duct 110, feedforward microphone 120, ANC system 130, speaker 140, and feedback microphone 150. Source 101 may be any noise or audio information external to housing 160, including ambient noise or the like. Audio playback system 100 may be a speaker, a headphone, an earbud, or the like. Although not shown, audio playback system 100 may communicate with a computing device, such as a mobile phone, a tablet, a smart watch, or the like. For example, the audio playback system 100 may include other components that are not shown in FIG. 1, such as a communication interface, wireless transceiver, or the like. The computing device may provide audio playback system 100 with instructions to output sounds, such as voices, music, podcasts, system alert sounds, other audio signals, or the like.

Feedforward microphone 120, feedback microphone 150, and speaker 140 may be in electrical communication with ANC system 130. Such electrical communication may enable ANC system 130 to analyze noise received by feedforward microphone 120 and feedback microphone 150 while also providing signals to speaker 140 to emit audio signals, such as to emit an anti-noise signal and sounds. Feedforward microphone 120 may be housed along a surface of housing 160 and may face away from the housing. Feedforward microphone 120 may receive external noise directly from source 101. Feedback microphone 150 may be housed within housing 160 and may face an interior portion of the housing. Feedback microphone 150 may receive external noise from source 101 through duct 110, audio signals from speaker 140, and/or other residual noise within housing 160.

Housing 160 may include an exit opening 161 leading from an interior of the housing to the exterior of the housing. As such, exit opening 161 may allow for output from speaker 140 to exit audio playback system 100. For example, where audio playback system 100 is an earbud, exit opening 161 may allow for output audio to enter a user's ear from speaker 140.

The ANC system 130 may reduce or remove noise for the user of the audio playback system 100 based on the external noise received from the feedforward microphone 120 and/or the feedback microphone 150. Using these microphones the ANC system 130 may emit an anti-noise audio signal from ambient noise, and may add this signal to the audio output of the audio playback system 100 so that it may cancel or reduce noise at the eardrum of the user. In addition, these microphones may be used to generate a correction audio signal from residual noise at the speaker of the audio playback system. The correction audio signal may also be added to the audio output of the audio playback system so that it may cancel or reduce noise at the eardrum of the user. As will be described in further detail below, the computational architecture for the ANC system 130 may include several components. For example, the ANC system 130 may include components that may identify noise to be canceled, channel response filters that may filter the noise using a transmission path transfer function and/or channel response filter, and components that may subtract a resulting anti-noise signal and/or correction signal from the audio output.

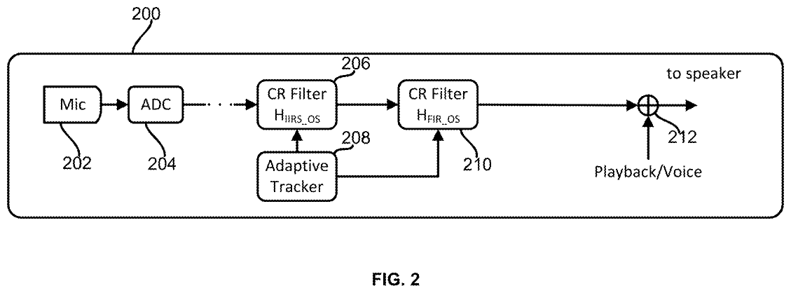

FIG. 2 depicts a block diagram of ANC system 200. While ANC system 130, described in connection with FIG. 1, is depicted at a system component level, ANC system 200 depicts particular circuitry that may be within the ANC system 130. Similar to ANC system 130 of FIG. 1, ANC system 200 may be included within an audio playback system, such as audio playback system 100 of FIG. 1. ANC system 200 includes microphone(s) 202, an analog to digital converter 204, channel response infinite impulse response (CR IIR) filter 206, adaptive tracker 208, channel response finite impulse response (CR FIR) filter 210, and subtractor 212.

Microphone(s) 202 may be the feedforward and/or feedback microphones described in connection with FIG. 1. In particular, microphone(s) 202 may include a feedforward microphone that may receive an external noise signal directly from a source. This received signal may be an analog signal. Microphone(s) 202 may include a feedback microphone that may receive an external noise signal from a source, other audio signals from a speaker, and/or other residual noise signals. The received signals may be analog signals. The microphone(s) 202 may output the signal(s) that it receives to the analog to digital converter (ADC) 204.

Analog to digital converter (ADC) 204 converts analog signals to digital signals. The ADC 204 may receive analog noise and/or audio signal(s) from the microphone(s) 202 and convert these signals to digital signals. In particular, the digital signals may be processed further by various components, both shown and not shown, of the ANC system 200.

The digital signals may be filtered by channel response infinite impulse response (CR IIR) filter 206. The CR IIR filter 206 may be a recursive filter. CR IIR filter 206 may be a filter that has an impulse response that is of infinite duration. The CR IIR filter 206 may use a linear combination of current and previous inputs, as well as previous outputs, to compute its current output. As a result of the use of its previous outputs, the CR IIR filter 206 may be considered to include feedback from its outputs. The linear combination of current and previous inputs as well as the previous outputs may make use of one or more filter coefficients as weights for each of these inputs/outputs. The filter coefficients may be associated with taps of the CR IIR filter 206. The CR IIR filter 206 may use its taps in filtering an input signal, such as by using its taps for computing the linear combination of its current and previous inputs and its previous outputs to compute an output signal. CR IIR filter 206 may be an adaptive filter. The coefficients associated with the taps of CR IIR filter 206 may be constantly adapted. For example, the coefficients of CR IIR filter 206 may be constantly updated, adapted, and/or computed to track the transmission path and/or channel response of the transmission path and/or channel associated with use of the CR IIR filter 206. This transmission path and/or channel may be constantly varying, thereby causing the coefficients of CR IIR filter 206 to be constantly changing. The coefficients may be changing, for example, in discrete, regular time intervals. CR IIR filter 206 may use adaptive tracker 208 to determine the values for its coefficients based on input information it receives from adaptive tracker 208. A mathematical representation of CR IIR filter 206 may be H_{IIR_OS}. The output of CR IIR filter 206 may be input to CR FIR filter 210 for further processing by CR FIR filter 210.

Adaptive tracker 208 may track the transmission path and/or channel response in order to update, adapt, and/or compute filter coefficients. For example, in order to mimic the passage of an audio signal and/or noise through the transmission path and/or channel, such as the transmission path and/or channel in which the audio playback system 100 described in connection with FIG. 1 operates, adaptive tracker 208 may make various measurements associated with the transmission path and/or channel. Adaptive tracker 208 may compute various filter coefficients based on these measurements. Adaptive tracker 208 may output these coefficients to CR IIR filter 206 and/or to CR FIR filter 210 to be used as tap coefficients in these filters.

CR FIR filter 210 may be a filter that has an impulse response that is of finite duration, settling to zero in finite time. The CR FIR filter 210 may use a linear combination of current and previous inputs in order to compute its current output. The CR FIR filter 210 may not use feedback from its previous outputs in order to compute the current output. The linear combination of current and previous inputs may make use of one or more filter coefficients as weights for each of these inputs. The filter coefficients may be associated with taps of the CR FIR filter 210. The CR FIR filter 210 may use its taps in filtering an input signal, such as by using its taps for computing the linear combination of its current and previous inputs to compute an output signal.

CR FIR filter 210 may be an adaptive filter. The coefficients associated with the taps of CR FIR filter 210 may be constantly adapted. For example, the coefficients of CR FIR filter 210 may be constantly updated, adapted, and/or computed to track the transmission path and/or channel response of the transmission path and/or channel associated with the CR FIR filter 210's use. This transmission path and/or channel may be constantly varying, thereby causing the coefficients of CR FIR filter 210 to be constantly changing. The coefficients may be changed, for example, in discrete, regular time intervals. CR FIR filter 210 may use adaptive tracker 208 to determine the values for its coefficients based on input information it receives from adaptive tracker 208. A mathematical representation of CR FIR filter 210 may be H_{FIR_OS}. The output of CR FIR filter 210 may be input to subtractor 212.

Together CR IIR filter 206 and CR FIR filter 210 may mimic the passage of an audio signal and/or noise through the transmission path and/or channel, such as the transmission path and/or channel in which the ANC system 200 and audio playback system 100, described in connection with FIG. 1, operates. Therefore, CR IIR filter 206 and CR FIR filter 210 may be used to emulate the channel response of the transmission path and/or channel in which the audio playback system 100 operates.

Subtractor 212 may subtract the output signal it receives from CR FIR filter 210 from a playback and/or voice audio signals that it receives. The playback and/or voice audio signals input to subtractor 212 may be received from a computing device. In particular, a computing device may provide the audio playback system, in which ANC system 200 operates, with signals and/or instructions to output audio playback signals such as sounds, music, podcasts, system alert sounds, and/or voice signals. These signals may be input to subtractor 212 and the output signal from CR FIR filter 210 may be subtracted from these signals. Subtractor 212 may output the result of the subtraction to a speaker, such as speaker 140 described in connection with FIG. 1. In some examples, subtractor 212 may instead be replaced by an adder that adds an anti-noise signal, such as the output signal from CR FIR filter 210 or a variant thereof, from the playback and/or voice audio signal.

ANC system 200 and/or the components of ANC system 200 may be implemented, in part or in whole, in software, such as in subroutines and code, and/or in hardware, such as in an Application Specific Integrated Circuit (ASIC), a Field Programmable Gate Array (FPGA), a Programmable Logic Device (PLD), a specialized or a general purpose Digital Signal Processor, a controller, a state machine, gated logic, discrete hardware components, or any other suitable devices, and/or a combination of both software and hardware.

ANC system 200 may operate at a rate that may be substantially higher than the bandwidth of the audio signal(s) from which it reduces or removes noise. Such high rate operation may result in oversampling of signal(s) in the ANC system. For example, ANC system 200 may operate at a sampling rate of 192 to 768 KHz, while the audio bandwidth may be less than 40 KHz. As a result, CR FIR filter 210 may have a large/long response duration, and may include a large number of taps. For example, CR FIR filter 210 may have a number of taps that is between 64 and 2048. Because of the large number of taps, the number of filter coefficients that need to be tracked, updated, adapted, and/or computed may be large. Such tracking of filter coefficients may be computationally expensive and may lead to significant power consumption. Additionally, the CR IIR filter 206 may operate on an oversampled input signal which may lead to poles and zeros close to the real axis on a pole-zero plot of the filter. This may lead to poor sensitivity of the CR IIR filter 206 due to its changing coefficients as well as low stability for this filter. In addition to being computationally expensive, tracking/updating/adapting/computing a large number of filter coefficients for both the CR IIR filter 206 and the CR FIR filter 210 may lead to stability issues for the ANC system 200.

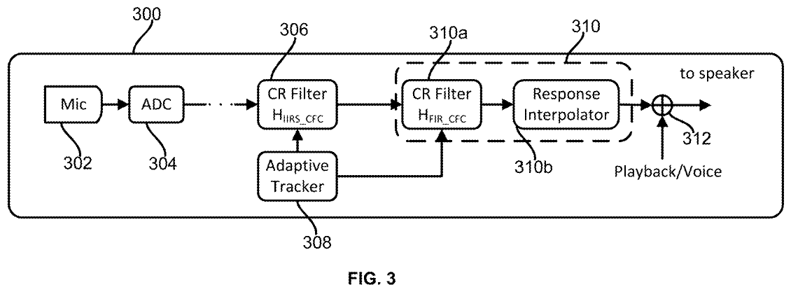

FIG. 3 depicts a block diagram of ANC system 300, which has a reduced complexity, or the like, as compared to the ANC system 200 (FIG. 2). ANC system 300 includes microphone(s) 302, an analog to digital converter 304, CR IIR filter 306, adaptive tracker 308, CR FIR filter 310a and response interpolator filter 310b, which are in a cascade filter configuration 310, and subtractor 312. ANC system 300 may be similar to ANC system 200 described in connection with FIG. 2, however, CR FIR filter 210 in ANC system 200 may be replaced by CR FIR filter 310a and response interpolator filter 310b in the cascade filter configuration 310. In some examples, CR IIR filter 306 may also vary from CR IIR filter 206.

Microphone(s) 302 may be the feedforward and/or feedback microphones described in connection with FIG. 1. In particular, microphone(s) 302 may include a feedforward microphone that may receive an external noise signal directly from a source. This received signal may be an analog signal. Microphone(s) 302 may include a feedback microphone that may receive an external noise signal from a source, other audio signals from a speaker, and/or other residual noise signals. The received signals may be analog signals. The microphone(s) 302 may output the signal(s) that it receives to the analog to digital converter (ADC) 304.

ADC 304 may convert analog signals to digital signals. The ADC 304 may receive analog noise/audio signal(s) from the microphone(s) 302 and may convert these signals to digital signals. The digital signals may then be filtered by the CR IIR filter 306.

The CR IIR filter 306 may be a recursive filter. CR IIR filter 306 may be a filter that has an impulse response that is of infinite duration. The CR IIR filter 306 may use a linear combination of the current and previous inputs as well as the previous outputs in order to compute its current output. As a result of the use of its previous outputs, the CR IIR filter 306 may be considered to include feedback from its outputs. The linear combination of current and previous inputs as well as the previous outputs may make use of one or more filter coefficients as weights for each of these inputs/outputs. The filter coefficients may be associated with taps of the CR IIR filter 306. The CR IIR filter 306 may use its taps in filtering an input signal, such as by using its taps for computing the linear combination of its current and previous inputs and its previous outputs to compute an output signal. CR IIR filter 306 may be an adaptive filter. The coefficients associated with the taps of CR IIR filter 306 may be constantly adapted. For example, the coefficients of CR IIR filter 306 may be constantly updated, adapted, and/or computed to track the transmission path and/or channel response of the transmission path and/or channel associated with the CR IIR filter 306's use. This transmission path and/or channel may be constantly varying, thereby causing the coefficients of CR IIR filter 306 to be constantly changing. The coefficients may be changing, for example, in discrete, regular time intervals. CR IIR filter 306 may use adaptive tracker 308 to determine the values for its coefficients based on input information it receives from adaptive tracker 308. A mathematical representation of CR IIR filter 306 may be H_{IIR_CFD}. The output of CR IIR filter 306 may be input to CR FIR filter 310a for further processing by CR FIR filter 310a.

Adaptive tracker 308 may track the transmission path and/or channel response in order to update, adapt, and/or compute filter coefficients. For example, in order to mimic the passage of an audio signal and/or noise through the transmission path and/or channel, such as the transmission path and/or channel in which the audio playback system 100 described in connection with FIG. 1 operates, adaptive tracker 308 may make various measurements associated with the transmission path and/or channel. Adaptive tracker 308 may compute various filter coefficients based on these measurements. Adaptive tracker 308 may output these coefficients to CR IIR filter 306 and/or to CR FIR filter 310a, to be used as tap coefficients in these filters.

CR FIR filter 310a may be a filter that has an impulse response that is of finite duration, settling to zero in finite time. The CR FIR filter 310a may use a linear combination of current and previous inputs in order to compute its current output. The CR FIR filter 310a may not use feedback from its previous outputs in order to compute the current output. The linear combination of current and previous inputs may make use of one or more filter coefficients as weights for each of these inputs. The filter coefficients may be associated with taps of the CR FIR filter 310a. The CR FIR filter 310a may use its taps in filtering an input signal, such as by using its taps for computing the linear combination of its current and previous inputs to compute an output signal. CR FIR filter 310a may be an adaptive filter. The coefficients associated with the taps of CR FIR filter 310a may be constantly adapted. For example, the coefficients of CR FIR filter 310a may be constantly updated, adapted, and/or computed to track the transmission path and/or channel response of the transmission path and/or channel associated with the CR FIR filter 310a's use. This transmission path and/or channel may be constantly varying, thereby causing the coefficients of CR FIR filter 310a to be constantly changing. The coefficients may be changing, for example, in discrete, regular time intervals. CR FIR filter 310a may use adaptive tracker 308 to determine the values for its coefficients based on input information it receives from adaptive tracker 308. A mathematical representation of CR FIR filter 310a may be H_{FIR_CFC}. The output of CR FIR filter 310a may be input to response interpolator filter 310b.

Response interpolator filter 310b may be fixed and therefore non-adaptive. The response interpolator filter 310b may have fixed coefficients and a pre-determined number of taps. The response interpolator filter 310b may receive an output signal from CR FIR filter 310a. The response interpolator filter 310b may up-sample and filter the signal it receives. In some examples, response interpolator filter 310b may have its number of taps adjusted a-priori or during operation of the ANC system 300 based on the power limitations of ANC system 300 and/or the type of playback or voice signal for which ANC system 300 is being used. For example, if ANC system 300 is power constrained and/or the playback or voice signal is of a low fidelity, the number of taps used by the response interpolator filter 310b may be reduced. In such cases, the shape of a frequency response profile of response interpolator filter 310b may not be smooth. As another example, if ANC system 300 is not power constrained and/or the playback or voice signal is of a high fidelity, the number of taps used by the response interpolator filter 310b may be increased. In such cases, the shape of a frequency response profile of response interpolator filter 310b may be smooth.

The response interpolator filter 310b may advantageously be implemented in a number of different ways. First, the response interpolator 310b may be of a constant length, and the composite response of the CR FIR filter 310a may be decomposed into a reduced length CR FIR filter and the response interpolator filter 310b to achieve an arbitrarily small error between the two filter designs as desired. Second, the design of the response interpolator filter 310b may be selected from a number of interpolator designs, depending on the filter response desired and to yield further economy. Third, the response interpolator 310b may be decomposed into several smaller filters, such as a cascaded integrator-comb (CIC) filter, to gain additional economy. Fourth, the response interpolator filter 310b may be decomposed in polyphase form, such as what is described in greater detail below.

Together CR IIR filter 306, CR FIR filter 310a, and response interpolator filter 310b may mimic the passage of an audio signal and/or noise through the transmission path and/or channel, such as the transmission path and/or channel in which the ANC system 300 and audio playback system 100, described in connection with FIG. 1, operates. Therefore, CR IIR filter 306, CR FIR filter 310a, and response interpolator 310b may be used to emulate the channel response of the transmission path and/or channel in which the audio playback system 100 operates.

The output of response interpolator filter 310b may be input to subtractor 312. Subtractor 312 may subtract the output signal it receives from interpolator filter 310b from a playback and/or voice audio signals that it receives. The playback and/or voice audio signals input to subtractor 312 may be received from a computing device. In particular, a computing device may provide the audio playback system, in which ANC system 300 operates, with signals and/or instructions to output audio playback signals such as sounds, music, or podcasts, and/or voice signals. These signals may be input to subtractor 312 and the output signal from CR FIR filter 310b may be subtracted from these signals. Subtractor 312 may output the result to a speaker, such as speaker 140 described in connection with FIG. 1. In some examples, subtractor 312 may instead be replaced by an adder that adds an anti-noise signal, such as the output signal from response interpolator filter 310b or a variant thereof, from the playback and/or voice audio signal.

ANC system 300 and/or the components of ANC system 300 may be implemented, in part or in whole, in software, such as in subroutines and code, and/or in hardware, such as in an Application Specific Integrated Circuit (ASIC), a Field Programmable Gate Array (FPGA), a Programmable Logic Device (PLD), a specialized or a general purpose Digital Signal Processing hardware, a controller, a state machine, gated logic, discrete hardware components, or any other suitable devices, and/or a combination of both software and hardware.

CR FIR filter 310a and response interpolator filter 310b may be in the cascade filter configuration 310. In some examples, CR FIR filter 310a and response interpolator filter 310b may be included together in a single hardware module. CR FIR filter 310a may be simpler in complexity and/or implementation when compared to CR FIR filter 210 described in connection with FIG. 2. CR FIR filter 310a may include several non-zero coefficients interleaved with zero coefficients. As a result, CR FIR filter 310a may have a fewer number of taps, associated with the non-zero coefficients, when compared to FIR filter 210. For example, FIR filter 310a may have four times to eight times fewer non-zero coefficients and filter taps when compared to FIR filter 210. For example, CR FIR filter 310a may include fewer non-zero coefficients than zero coefficients.

In addition, adaptive tracker 308 may track and update only the non-zero coefficients of CR FIR filter 310a, and output these coefficient values for use by the CR FIR filter 310a. This may result in the adaptive tracker 308 tracking and updating fewer coefficients, when compared to adaptive tracker 208. Thus, the coefficient tracking for the CR FIR filter 310a within the cascade filter configuration may be less complex when compared to coefficient tracking for CR FIR filter 210. Therefore, because of such reduced complexity, CR FIR filter 310, may have a faster convergence rate when compared to the convergence rate of CR FIR filter 210. Additionally, response interpolator filter 310b may have a small number of taps and have fixed coefficients that are not adapted. For example, response interpolator filter 310b may have 5 to 17 taps.

As a result of its reduced complexity described above, the cascade filter configuration 310 may have lower computational requirements when compared to CR FIR filter 210, which the cascade filter configuration 310 may replace in an ANC system. For example, CR FIR filter 310a, represented by H_{FIR_CFC}, may have four times to eight times fewer non-zero filter coefficients when compared to CR FIR filter 210, such as when K=4 or K=8. Additionally, response interpolator filter 310b may have a fixed number of taps that are not adapted, such as 5 to 17 taps. Thus, CR FIR filter 310a and response interpolator filter 310b in the cascade filter configuration 310 may have two times to five times fewer non-zero filter coefficients and corresponding filter taps when compared to CR FIR filter 210. As such, because computational complexity may be directly proportional to the number of non-zero filter coefficients/taps in the filter, CR FIR filter 310a and response interpolator filter 310b in the cascade filter configuration 310 may have two times to five times lower computational complexity when compared to CR FIR filter 210. In addition, such reduced computational complexity may enable a correspondingly lower power consumption of CR FIR filter 310a and response interpolator filter 310b in the cascade filter configuration 310 when compared to CR FIR filter 210, which these filters may replace. Moreover, CR IIR filter 306, represented by H_{IIR_CFC}, may have poles and zeros away from the unit circle on a pole-zero plot of the filter. This may allow for easier implementation of the filter at lower word widths.

As discussed above, there may be a reduction in the number of filter taps in cascade filter configuration 310 when compared to CR FIR filter 210. The cascade filter configuration 310 may effectively replace CR FIR filter 210 in an ANC system, resulting in a reduction in complexity and without any significant loss in fidelity. As an example, if CR FIR filter 210, described in connection with FIG. 2, includes 64 filter taps and requires 4× oversampling of its input signal, the cascade filter configuration 310 may include 25 non-zero taps. In particular, CR FIR filter 310a of the cascade filter configuration may include 64/4=16 taps, where a reduction in the number of taps are a result of eliminating the zero coefficient taps from the 4×oversampling. The response interpolator filter 310b may include 9 taps. As a result the cascade filter configuration 310 may have 16+9=25 taps, and may have a complexity reduction of 64 taps/25 taps=2.6. As another example, if CR FIR filter 210, described in connection with FIG. 2, includes 256 filter taps and requires 8× oversampling of its input signal, the cascade filter configuration 310 may include 49 non-zero taps. In particular, CR FIR filter 310a of the cascade filter configuration may include 256/8=32 taps, where a reduction in the number of taps are a result of eliminating the zero coefficient taps from the 8× oversampling. The response interpolator filter 310b may include 17 taps. As a result the cascade filter configuration 310 may have 32+17=49 taps, and may have a complexity reduction of 256 taps/49 taps=5.2.

As a result of the reduced complexity of the cascade filter configuration 310, described above, the signal filtering performed within ANC system 300 may have benefits such as lower computational requirements, a lower number of filter taps, a reduced complexity, a lower power consumption, a faster response duration with faster convergence capability, a high degree of stability, and a lower computational expense when compared to the filtering performed within ANC system 200.

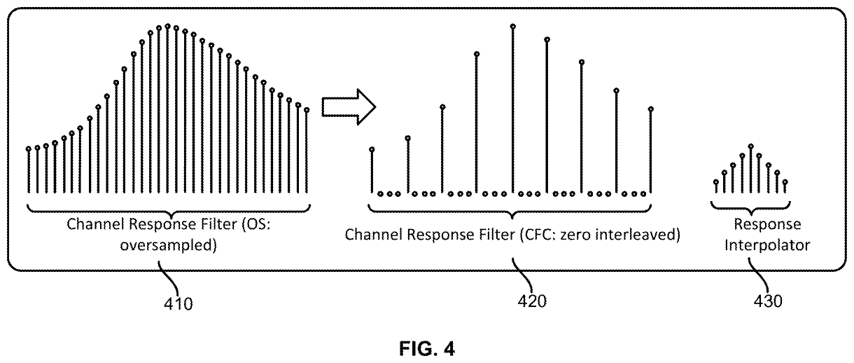

FIG. 4 shows example graphs of the channel frequency responses of filters used in ANC systems. FIG. 4 may include channel frequency response graphs 410, 420, and 430. A channel frequency response graph of a filter may show the quantitative measure of the output frequency spectrum of the filter in response to an input. Such a channel frequency response graph for a particular filter may show the magnitude with which certain frequencies are accentuated or attenuated by the particular filter. For example, channel frequency response graph 410 may show the frequency response of a CR FIR filter in a conventional ANC system, such as CR FIR filter 210 described in connection with FIG. 2. As another example, channel frequency response graph 420 may show the frequency response of a CR FIR filter in a reduced complexity ANC system, such as CR FIR filter 310a described in connection with FIG. 3. As yet another example, channel frequency response graph 430 may show the frequency response of a response interpolator filter in a reduced complexity ANC system, such as response interpolator filter 310b described in connection with FIG. 3. FIG. 4 shows that the combined channel frequency response profile of the cascade filter configuration 310, which may be a combination of the graphs 420 and 430, may be substantially similar/equal to the channel frequency response profile, as shown in graph 410, of the conventional CR FIR filter, which the cascade replaces. Therefore, although the cascade filter configuration may be of a reduced complexity when compared to the conventional CR FIR filter, the filtering capability and frequency response profile of the cascade filter configuration may be substantially similar/equal to the conventional CR FIR filter.

In some examples, a CR FIR filter, such as CR FIR filter 310a described in connection with FIG. 3, may be implemented in a particular manner. For example, this filter may be implemented by generating a CR FIR filter for operation at the Nyquist frequency and replacing each delay in the filter with an integer number, K, delays. A mathematical representation of the resulting filter H_{FIR_CFC}, may be H_{FIR_CFC}(z⁻¹)=H_{FIR_NYSQUIST}(z^{-K}) where H_{FIR_NYQUIST} may be the mathematical representation of the CR FIR filter generated for operation at the Nyquist frequency. H_{FIR_NYQUIST} may represent a “zero removed” version of a CR FIR filter. In some examples, the resulting filter, which may be mathematically represented as H_{FIR_CFC}, may have a frequency response profile substantially similar to what is shown in channel frequency response graph 420 described in connection with FIG. 4. As described above, graph 420 may show a zero interleaved impulse response of the CR FIR filter, such as CR FIR filter 310a. The filter generated and mathematically represented by H_{FIR_NYQUIST} may have a response that is K times shorter than a conventional CR FIR filter, and may also have lower computational requirements than the conventional CR FIR filter.

In some example implementations, CR IIR filter 306 may operate at the Nyquist frequency and each delay in the filter may be replaced with an integer number, K, delays. A mathematical representation of the resulting filter H_{IIR_CFC}, may be H_{IIR_CFC}(z⁻¹)=H_{IIR_NYQUIST}(z^{-K}) where H_{IIR_NYQUIST} may be the mathematical representation of the CR IIR filter generated for operation at the Nyquist frequency. H_{IIR_NYQUIST} may represent a “zero removed” version of a CR IIR filter. In some examples, the resulting filter, which may be mathematically represented as H_{IIR_CFC}, may not have a reduction in length, in terms of number of taps or order, when compared to a conventional CR IIR filter. The filter generated and mathematically represented by H_{IIR_NYQUIST} may have poles and zeros away from the real axis on a pole-zero plot of the filter. This may allow for better stability and lower sensitivity of the filter when compared to a conventional CR IIR filter.

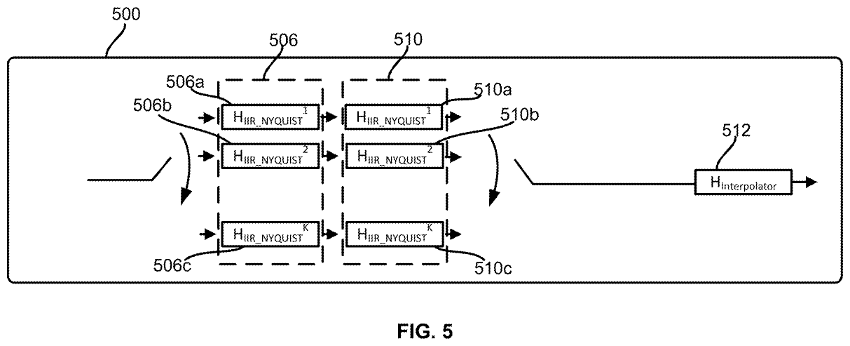

FIG. 5 depicts a block diagram of an example implementation of filters in an ANC system 500. ANC system 500 includes a set of filters 506a-c implementing a CR IIR filter 506, a set of filters 510a-k implementing a CR FIR filter 510, and a response interpolator filter 512. ANC system 500 may be similar to ANC system 300 described in connection with FIG. 3, however, the CR IIR filter 306 in ANC system 300 may be replaced by the CR IIR filter 506, the CR FIR filter 310a may be replaced by the CR FIR filter 510 and the response interpolator filter 310b may be replaced by the response interpolator filter 512. CR IIR filter 506 may be mathematically represented by H_{IIR_CFC}, and may be implemented as a polyphase filter. CR FIR filter 510 may be mathematically represented by H_{FIR_CFC}, and may be implemented as a polyphase filter. In particular, each phase of the polyphase filter may implement a “zero removed” version of the filter. For example, as discussed above, the zero-removed version of the CR IIR filter 506 may be mathematically represented by H_{IIR_NYQFIST}. As another example, as discussed above, the zero-removed version of the CR FIR filter 510 may be mathematically represented by H_{FIR_NYQUIST} The polyphase implementation of the CR IIR filter 506 may have an integer number, K, filters, as shown by elements 506a-c, operating in parallel. The polyphase implementation of the CR FIR filter 510 may have K filters, as shown by elements 510a-c, operating in parallel. Each of the K filter paths operating in parallel may be associated with a number of samples of the input signal that it receives. For example, the filter path, also known as a phase, which includes filters 506a and 510a may receive the 1^{st}, (K+1)^{th}, (2K+1)^{th}, etc. input samples of the input signal to be filtered. As another example, the filter path that includes filters 506b and 510b may receive the 2^{nd}, (K+2)^{th}, (2K+2)^{th}, etc. input samples of the input signal. As yet another example, the filter path that includes filters 506c and 510c may receive the K^{th}, 2K^{th}, 3K^{th}, etc. input sample of the input signal. The selector switches, or the like, which may route the input samples to the successive filters 506a, 506b, and 506c, and which may collect the output from the filters 510a, 510b, and 510c may not be distinct. Each of the filters in a path/phase, such as filters 506a and 510a, may perform N/K multiply and accumulate operations to generate an output sample. Here N may be an integer number of taps in the conventional version of the CR IIR and CR IIR filters. If an input is received by each path/phase every time period, Ts, the path/phase will output one sample every time period, Ts. Each of the outputs of the paths/phases in the polyphase filters may be output to a response interpolator filter 512. Response interpolator filter 512 may be substantially similar in form and in function to response interpolator filter 310b described in connection with FIG. 3. Such use of a polyphase design of CR IIR filter 506 and CR FIR filter 510 may reduce computational complexity by a factor of K when compared to a conventional CR IIR filter and CR FIR filter design.

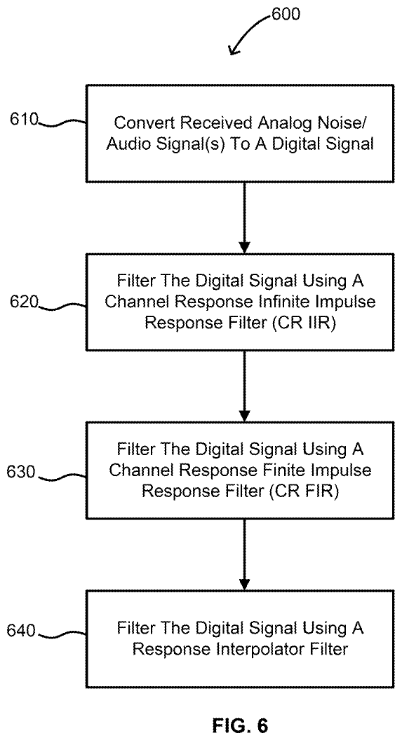

FIG. 6 is a flow diagram of example process 600 for filtering an audio signal. The process 600 may be performed, by way of example, by an ANC system operating within or as a portion of an electronic device, such as what is described in connection with FIGS. 1-5 and 7. While the operations of the process 600 are described in a particular order, it should be understood that the order may be modified and operations may be performed in parallel. Moreover, it should be understood that operations may be added or omitted.

In block 610, analog noise/audio signal(s) may be received from microphone(s) in an ANC system, such as the microphone(s) 302 described in connection with FIG. 3, and these signal(s) may be converted to a digital signal. For example, ADC 304, described in connection with FIG. 3, may convert the analog signal(s) to a digital signal. The digital signal may be processed further before being processed by a filter within the ANC system.

In block 620, the digital signal may be filtered by CR IIR filter, such as CR IIR filter 306 described in connection with FIG. 3 or CR IIR filter 506 described in connection with FIG. 5. The CR IIR filter may be an adaptive filter that may have filter coefficients that are updated, adapted, and/or computed to track the transmission path and/or channel response of the transmission path and/or channel associated with the CR IIR filter's use, such as what is described in relation to FIG. 3. The CR IIR filter may filter the digital signal and output the filtered digital signal.

In block 630, the digital signal output by the CR IIR filter may be filtered by CR FIR filter, such as CR FIR filter 310a described in connection with FIG. 3 or CR FIR filter 510 described in connection with FIG. 5. The CR FIR filter may be an adaptive filter that may have its non-zero filter coefficients updated, adapted, and/or computed to track the transmission path and/or channel response of the transmission path and/or channel associated with the CR FIR filter's use, such as what is described in relation to FIG. 3. The CR FIR filter may filter the digital signal from the CR IIR filter and output the filtered digital signal.

In block 640, the digital signal output by the CR FIR filter may be filtered by a response interpolator filter, such as response interpolator filter 310b described in connection with FIG. 3 or response interpolator filter 512 described in connection with FIG. 5. The response interpolator filter may have fixed filter coefficients and a fixed and pre-determined number of taps. The response interpolator may filter the digital signal from the CR FIR filter and output the filtered digital signal.

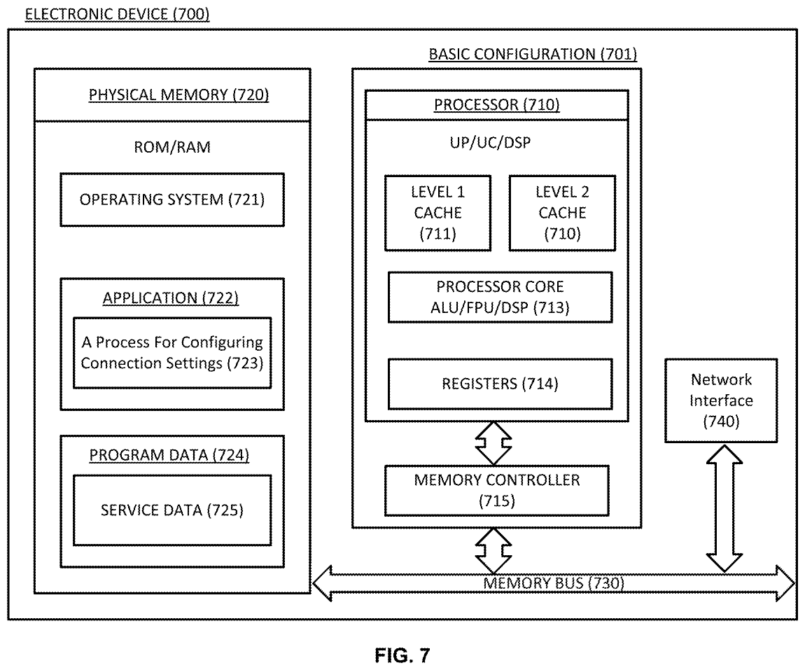

FIG. 7 is a block diagram of an example electronic device 700. The electronic device 700 may include one or more processors 710, system memory 720, a bus 730, the networking interface(s) 740, and other components (not shown), such as storage(s), output device interface(s), input device interface(s). A bus 730 may be used for communicating between the processor 710, the system memory 720, the networking interface(s) 740, and other components.

Depending on the desired configuration, the processor 710 may be of any type including but not limited to a microprocessor, a microcontroller, a digital signal processor (DSP), or any combination thereof. The processor 710 may include one more levels of caching, such as a level one cache 711 and a level two cache 712, a processor core 713, and registers 714. The processor core 713 may include an arithmetic logic unit (ALU), a floating point unit (FPU), a DSP core, or any combination thereof. A memory controller 715 may also be used with the processor 710, or in some implementations the memory controller 715 can be an internal part of the processor 710.

Depending on the desired configuration, the physical memory 720 may be of any type including but not limited to volatile memory, such as RAM, non-volatile memory, such as ROM, flash memory, etc., or any combination thereof. The physical memory 720 may include an operating system 721, one or more applications 722, and program data 724. The application 722 may include a process of writing data to physical memory. Non-transitory computer-readable medium program data 724 may include storing instructions that, when executed by the one or more processing devices, implement a process for filtering an audio signal 723. In some examples, the application 722 may be arranged to operate with program data 724 on an operating system 721.

The electronic device 700 may have additional features or functionality, and additional interfaces to facilitate communications between the basic configuration 701 and any required devices and interfaces.

Physical memory 720 may be an example of computer storage media. Computer storage media includes, but is not limited to, RAM, ROM, EEPROM, flash memory or other memory technology, or any other medium which can be used to store the desired information and which can be accessed by electronic device 700. Any such computer storage media can be part of the device 700.

Network interface(s) 740 may couple the electronic device 700 to a network (not shown) and/or to another electronic device (not shown). In this manner, the electronic device 700 can be a part of a network of electronic devices, such as a local area network (“LAN”), a wide area network (“WAN”), an intranet, or a network of networks, such as the Internet. In some examples, the electronic device 700 may include a network connection interface for forming a network connection to a network and a local communications connection interface for forming a tethering connection with another device. The connections may be wired or wireless. The electronic device 700 may bridge the network connection and the tethering connection to connect the other device to the network via the network interface(s) 740. Any or all components of electronic device 700 may be used in conjunction with the subject of the present disclosure.

The electronic device 700 may be implemented as a portion of a small form factor portable (or mobile) electronic device such as a speaker, a headphone, an earbud, a cell phone, a smartphone, a smartwatch, a personal data assistant (PDA), a personal media player device, a tablet computer (tablet), a wireless web-watch device, a personal headset device, a wearable device, an application-specific device, or a hybrid device that include any of the above functions. The electronic device 700 may also be implemented as a personal computer including both laptop computer and non-laptop computer configurations. The electronic device 700 may also be implemented as a server or a large-scale system.

Aspects of the present disclosure may be implemented as a computer implemented process, a system, or as an article of manufacture such as a memory device or non-transitory computer readable storage medium. The computer readable storage medium may be readable by an electronic device and may comprise instructions for causing an electronic device or other device to perform processes and techniques described in the present disclosure. The computer readable storage medium may be implemented by a volatile computer memory, non-volatile computer memory, solid state memory, flash drive, and/or other memory or other non-transitory and/or transitory media. Aspects of the present disclosure may be performed in different forms of software, firmware, and/or hardware. Further, the teachings of the disclosure may be performed by an application specific integrated circuit (ASIC), field programmable gate array (FPGA), or other component, for example.

Aspects of the present disclosure may be performed on a single device or may be performed on multiple devices. For example, program modules including one or more components described herein may be located in different devices and may each perform one or more aspects of the present disclosure. As used in this disclosure, the term “a” or “one” may include one or more items unless specifically stated otherwise. Further, the phrase “based on” is intended to mean “based at least in part on” unless specifically stated otherwise.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible examples. Further, the same reference numbers in different drawings can identify the same or similar elements.

Numerous examples are described in the present application, and are presented for illustrative purposes only. The described examples are not, and are not intended to be, limiting in any sense. One of ordinary skill in the art will recognize that the disclosed subject matter may be practiced with various modifications and alterations, such as structural, logical, software, and electrical modifications. It should be understood that the described features are not limited to usage in the one or more particular examples or drawings with reference to which they are described, unless expressly specified otherwise.

1. An active noise cancellation system, the system comprising:
an infinite impulse response filter configured to filter a digital signal and output a first filtered digital signal; and
a cascaded filter configuration in communication with the infinite impulse response filter, the cascaded filter configuration configured to filter the first filtered digital signal and output an audio signal;
wherein the cascaded filter configuration includes:
an adaptive finite impulse response filter configured to filter the first filtered digital signal and to output a second filtered digital signal, and
a response interpolator filter configured to filter the second filtered digital signal and output the audio signal.

2. The system of claim 1, further comprising an adaptive tracker in communication with the cascaded filter configuration, the adaptive tracker configured to track, based on a channel response, non-zero coefficients of at least one of the infinite impulse response filter and the adaptive finite impulse response filter.

3. The system of claim 2, wherein the non-zero coefficients are used by the at least one of the infinite impulse response filter and the adaptive finite impulse response filter.

4. The system of claim 1, wherein the response interpolator filter is a fixed interpolator.

5. The system of claim 1, wherein the adaptive finite impulse response filter includes interleaved zero coefficients.

6. The system of claim 1, wherein the adaptive finite impulse response filter is implemented as a polyphase filter.

7. The system of claim 1, wherein the infinite impulse response filter is implemented as a polyphase filter.

8. The system of claim 1, further comprising an analog to digital converter in communication with the infinite impulse response filter, the analog to digital converter configured to convert at least one analog signal to the digital signal.

9. The system of claim 1, further comprising a subtractor in communication with the cascaded filter configuration, the subtractor configured to:
receive a playback signal, and
subtract the audio signal from the playback signal.

10. The system of claim 1, wherein the active noise cancellation system is arranged within an earbud.

11. A non-transitory computer-readable medium storing instructions, that when executed by one or more processors, cause the one or more processors to:
filter a digital signal to produce a first filtered digital signal using an infinite impulse response filter;
filter the first filtered digital signal to output a second filtered digital signal using an adaptive finite impulse response filter;
filter the second filtered digital signal using a response interpolator filter; and
produce an audio signal based on an output of the response interpolator filter.

12. The non-transitory computer-readable medium of claim 11, wherein the instructions, that when executed by the one or more processors, cause the one or more processors to:
track, based on a channel response, non-zero coefficients of at least one of the infinite impulse response filter and the adaptive finite impulse response filter.

13. The non-transitory computer-readable medium of claim 12, wherein the instructions, that when executed by the one or more processors, cause the one or more processors to:
output the non-zero coefficients for use by the at least one of the infinite impulse response filter and the adaptive finite impulse response filter.

14. The non-transitory computer-readable medium of claim 11, wherein the instructions, that when executed by the one or more processors, cause the one or more processors to:
convert at least one analog signal to the digital signal.

15. The non-transitory computer-readable medium of claim 11, wherein the instructions, that when executed by the one or more processors, cause the one or more processors to:
receive a playback signal, and
subtract the audio signal from the playback signal.

16. A method of active noise cancellation, the method comprising:
filtering a digital signal to produce a first filtered digital signal using an infinite impulse response filter;
filtering the first filtered digital signal to output a second filtered digital signal using an adaptive finite impulse response filter;
filtering the second filtered digital signal using a response interpolator filter; and
producing an audio signal based on an output of the response interpolator filter.

17. The method of claim 16, further comprising:
tracking, based on a channel response, non-zero coefficients of at least one of the infinite impulse response filter and the adaptive finite impulse response filter.

18. The method of claim 17, further comprising:
outputting the non-zero coefficients for use by the at least one of the infinite impulse response filter and the adaptive finite impulse response filter.

19. The method of claim 16, further comprising:
converting at least one analog signal to the digital signal.

20. The method of claim 16, further comprising:
receiving a playback signal, and
subtracting the audio signal from the playback signal.
